(19) United States
(12) Patent Application Publication
(10) Pub. No.: US 2024/0333858 A1
(43) Pub. Date: Oct. 3, 2024

(54) PROCESSING DEVICE, IMAGE PROCESSING DEVICE, AND IMPORT DATA PROCESSING METHOD

(71) Applicant: Sharp Kabushiki Kaisha, Sakai City (JP)

(72) Inventor: Akitoshi MASUDA, Sakai City (JP)

(21) Appl. No.: 18/611,947

(22) Filed: Mar. 21, 2024

(30) Foreign Application Priority Data
Mar. 31, 2023 (JP) 2023-057720

(51) Int. Cl. H04N 1/44; H04N 1/00

(52) U.S. Cl. CPC H04N 1/4426; H04N 1/00212; H04N 1/00217; H04N 1/00244; H04N 1/00344; H04N 1/00347; H04N 1/0097; H04N 1/4433; H04N 2201/0094

(57) ABSTRACT

A processing device includes an authenticator that can apply first authentication information and authenticate to a service using second authentication information, a storage that stores a device setting including the first authentication information and the second authentication information, and one or more controllers that can verify import data imported to a device and reflect the import data on the device setting stored in the storage. The one or more controller compare third authentication information with the first authentication information when determining that the import data includes the third authentication information as a result of verification of the import data, maintain the second authentication information when determining that the third authentication information and the first authentication information are the same authentication information, and reflect the third authentication information instead of the first authentication information on the device setting and delete the second authentication information from the storage when determining that the third authentication information and the first authentication information are not the same authentication information.

### TECHNICAL FIELD

The present disclosure relates to a processing device and the like.

### BACKGROUND ART

There is known a technology for cloning a device having the same device setting as that of a different device by importing the device setting exported from the different device as import data, or restoring a device setting by importing a device setting exported from a device itself (hereinafter, may be referred to as device cloning).

For example, in the case of a multifunction peripheral having a configuration as a processing device, exported data includes authentication information for a (cloud) service or the like such as a mail transmission service, in addition to setting information for executing a job in each mode such as copy, print, scan, fax, or mail transmission/reception, history information, user information of a user who uses the multifunction peripheral, and the like. Then, the export data is reflected as import data in a target multifunction peripheral, and thus the existing device setting held by the multifunction peripheral, inclusive of the authentication information, can be collectively rewritten.

Regarding import of a device setting including authentication information, it is known that when an information processing device uses a cloud service that requires OAuth 2.0 (hereinafter simply referred to as OAuth authentication) as an authentication method and an export file exported from another information processing device using the same cloud service is imported to the information processing device, data read from the export file is stored with a token included therein, and authentication is performed using the token when the same cloud service is used.

### SUMMARY

### Technical Problem

An object of the present disclosure is to provide a processing device and the like that can appropriately manage authentication information in importing the import data including the authentication information.

### Solution to Problem

To solve the above problem, a processing device according to the present disclosure includes an authenticator that can apply first authentication information and authenticate to a service using second authentication information, a storage that stores a device setting including the first authentication information and the second authentication information, and one or more controllers that can verify import data imported to a device and reflect the import data on the device setting stored in the storage. The one or more controllers compare third authentication information with the first authentication information when determining that the import data includes the third authentication information as a result of verification of the import data, maintain the second authentication information when determining that the third authentication information and the first authentication information are the same authentication information, and reflect the third authentication information instead of the first authentication information on the device setting and delete the second authentication information from the storage when determining that the third authentication information and the first authentication information are not the same authentication information.

Moreover, an image processing device according to the present disclosure includes a processing device including an authenticator that can apply first authentication information and authenticate to a service using second authentication information, a storage that stores a device setting including the first authentication information and the second authentication information, and one or more controllers that can verify import data imported to a device and reflect the import data on the device setting stored in the storage, the one or more controllers comparing third authentication information with the first authentication information when determining that the import data includes the third authentication information as a result of verification of the import data, maintaining the second authentication information when determining that the third authentication information and the first authentication information are the same authentication information, and reflecting the third authentication information instead of the first authentication information on the device setting and deleting the second authentication information from the storage when determining that the third authentication information and the first authentication information are not the same authentication information, and an image processor that performs transmission processing of an image based on an authentication result in the service.

Furthermore, a processing method of import data according to the present disclosure includes storing a device setting including first authentication information and second authentication information in a storage device, verifying import data imported to a device, comparing third authentication information with the first authentication information when determining that the import data includes the third authentication information as a result of verification of the import data, maintaining the second authentication information when determining that the third authentication information and the first authentication information are the same authentication information, and reflecting the third authentication information instead of the first authentication information on the device setting and deleting the second authentication information from the storage device when determining that the third authentication information and the first authentication information are not the same authentication information.

### Advantageous Effects of Invention

According to the present disclosure, it is possible to provide a processing device and the like capable of appropriately managing authentication information in import of import data including the authentication information.

### BRIEF DESCRIPTION OF DRAWINGS

FIG. 1 is a diagram for illustrating a connection mode between a multifunction peripheral, another multifunction peripheral, an authentication service, and a mail server.

FIG. 2 is a functional configuration diagram of the multifunction peripheral.

FIG. 3 is a functional configuration diagram of the other multifunction peripheral.

FIG. 4 is a diagram for illustrating SMTP setting items in a multifunction peripheral that supports an OAuth authentication method and SMTP setting items in a multifunction peripheral that does not support the OAuth authentication method.

FIG. 5 is a flowchart illustrating a processing flow according to the first embodiment.

FIG. 6 is a flowchart for illustrating a processing flow according to the first embodiment.

FIG. 7 is a flowchart for illustrating a processing flow according to the first embodiment.

FIG. 8 is a diagram for illustrating a configuration example of export data.

FIG. 9 is a diagram for illustrating a configuration example of the export data.

FIG. 10 is a diagram for illustrating a configuration example of the export data.

FIG. 11 is a diagram for illustrating a configuration example of the export data.

FIG. 12 is a diagram for illustrating a configuration example of the export data.

FIG. 13 is a diagram for illustrating a configuration example of the export data.

FIG. 14 is a diagram for illustrating a configuration example of the export data.

FIG. 15 is a diagram for illustrating a configuration example of the export data.

FIG. 16 is a diagram for illustrating a configuration example of the export data.

FIG. 17 is a diagram for illustrating an operation example.

FIG. 18 is a diagram for illustrating an operation example.

FIG. 19 is a diagram for illustrating an operation example.

FIG. 20 is a flowchart for illustrating a processing flow according to a second embodiment.

FIG. 21 is a flowchart for illustrating a processing flow according to the third embodiment.

### DESCRIPTION OF EMBODIMENTS

Embodiments according to the present disclosure will be described below with reference to the drawings. Note that the following embodiments are examples for explaining the present disclosure, and the technical content of the explanation described in the claims is not limited to the following description.

In a multifunction peripheral, execution of a mail transmission/reception job requires authentication to a mail server such as a simple mail transfer protocol (SMTP) server. In recent years, as a more secure authentication method, for example, an authentication method such as OAuth authentication that requires authorization in advance is becoming mainstream.

The OAuth authentication is a technology in which authorization of permission to use a resource is performed on an authentication service, and authentication with, for example, a mail server is performed using a token obtained to be a result of the authorization.

Here, when an authentication method of authentication information included in import data based on device cloning is an OAuth authentication method and authentication information (token) related to OAuth authentication is rewritten, re-authorization processing for an OAuth authentication service by a user having permission (administrator user) is required. In this case, a mail transmission/reception job via a mail server cannot be executed until the re-authorization is obtained from the OAuth authentication service, which causes a decrease in productivity. On the other hand, a configuration in which the authentication information (token) can be also used among a plurality of devices without the re-authorization from the OAuth authentication service is ethically not preferable.

According to the present disclosure, when authentication information related to OAuth authentication is imported to a device that supports an OAuth authentication method, rewriting of existing first authentication information is omitted and a token serving as second authentication information is maintained in a case where the imported authentication information is the same as the first authentication information serving as an existing device setting of the import destination, and the first authentication information is rewritten with the imported authentication information and the token serving as the existing device setting is deleted in a case where the imported authentication information is different from the existing first authentication information. Thus, according to the following embodiments, it is possible to achieve a processing device and the like capable of appropriately reflecting the authentication information related to the OAuth authentication in the device setting of the import destination without incorrectly reusing the token.

### 1. First Embodiment

### 1.1 Overall Configuration

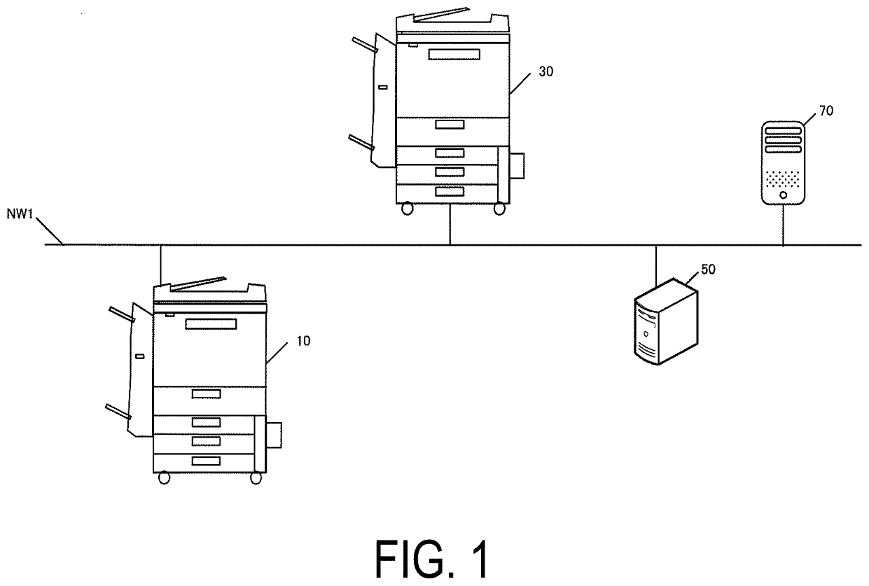

FIG. 1 is a diagram for illustrating an example of a connection mode between a multifunction peripheral 10 serving as an image processing device on which a processing device according to the present embodiment is mounted, another multifunction peripheral 30 capable of exporting a device setting to the outside, an authentication service 50, and a mail server 70.

The multifunction peripheral 10 according to the first embodiment is an image processing device that can execute a job in each mode such as copy, print, scan, fax, or mail transmission/reception in one housing. Note that, in the present disclosure, the multifunction peripheral 10 will be described as one mode of the image processing device. However, the mode of the image processing device is not particularly limited as long as the processing device according to the present disclosure is mounted at the image processing device and the image processing device has an image processing function. The image processing device may be an image processing device other than the multifunction peripheral 10, such as a copier, a printer, or a fax. The multifunction peripheral 10 is an image processing device capable of reflecting export data exported from the multifunction peripheral 30 as import data in the device setting of the multifunction peripheral 10.

The multifunction peripheral 10 is connected to the multifunction peripheral 30, the authentication service 50, and the mail server 70 via a network NW1. The multifunction peripheral 10 is configured to communicate with the multifunction peripheral 30, the authentication service 50, and the mail server 70 using a communication protocol such as a hypertext transfer protocol (HTTP). Note that the network NW1 is not particularly limited as long as the network NW1 is a network line such as a local area network (LAN), a wide area network (WAN), the Internet, a telephone line, or a fax line. Note that the multifunction peripheral 10 can transmit and receive a mail via the mail server 70 based on a token acquired from the authentication service 50.

The multifunction peripheral 30 is an image processing device having the same or substantially the same device configuration and functional configuration as those of the multifunction peripheral 10. The multifunction peripheral 30 can export authentication information for the authentication service 50 as first device setting information, in addition to setting information for executing a job in each mode such as copy, print, scan, fax, or mail transmission/reception, history information, user information of a user who uses the multifunction peripheral, and the like. Note that, in the following description, it is assumed that the multifunction peripheral 30 is configured to support the OAuth authentication method as an authentication method and export first device setting information including authentication information related to the OAuth authentication.

The authentication service 50 can be configured as an authentication server that authorizes use of a resource by, for example, performing an authorization code flow based on OAuth 2.0 authentication. The configuration of the authentication service 50 is not limited as long as the authentication service 50 is configured to generate an authorization code, a token, and the like in accordance with the success or failure of authorization.

The mail server 70 is a server that supports the SMTP authentication method or the OAuth authentication method as an authentication method and that is capable of providing a service related to mail transmission/reception in accordance with the success or failure of an authentication result based on acquired authentication information such as a username (user ID), a password, or a token.

### 1.2 Functional Configuration

### 1.2.1 Multifunction Peripheral 10

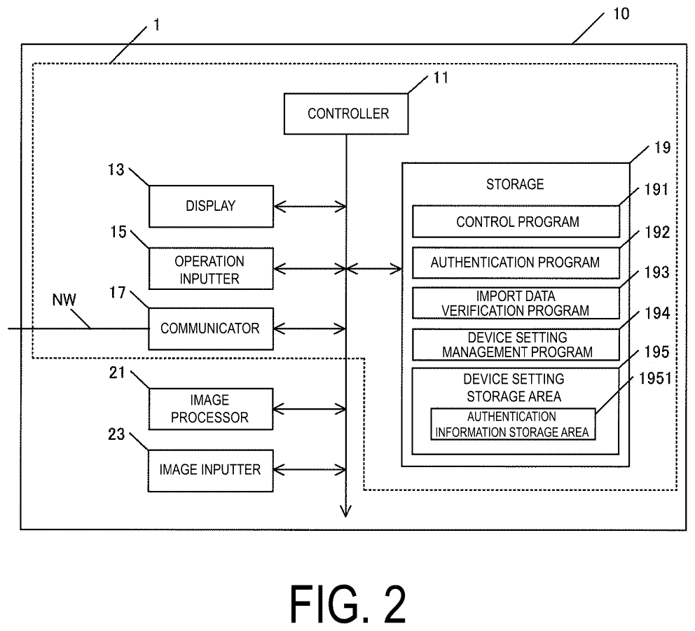

A functional configuration of the multifunction peripheral 10 according to the first embodiment will be described. FIG. 2 is a functional configuration diagram of the multifunction peripheral 10. The multifunction peripheral 10 includes an image processor 21 and an image inputter 23, in addition to the configuration of a processing device 1 indicated by a dotted frame in the drawing.

The controller 11 controls the entire multifunction peripheral 10. The controller 11 is configured of, for example, one or multiple arithmetic devices (central processing units (CPUs) or the like). The controller 11 implements a function thereof by reading and executing various programs stored in a storage 19.

The display 13 displays various types of information for a user or the like. The display 13 can be constituted by, for example, a liquid crystal display (LCD), an organic electro-luminescence (EL) display, or the like.

The operation inputter 15 receives an input of information by the user or the like. The operation inputter 15 can be constituted by, for example, various input devices such as operation keys (for example, hardware keys and software keys) and buttons. The operation inputter 15 can be configured as a touch panel that enables input via the display 13. In this case, as an input method for the touch panel, for example, a general method such as a resistance film method, an infrared beam method, an electromagnetic induction method, or an electrostatic capacitance method can be employed.

A communicator 17 includes, for example, one or both of wired and wireless interfaces for communicating with other devices (e.g., the multifunction peripheral 30, the authentication service 50, and the mail server 70) via the network NW1 such as a LAN, a WAN, the Internet, a telephone line, or a fax line. In addition, the communicator 17 may include an interface related to a (short-range) wireless communication technology such as Bluetooth (trade name), near-field communication (NFC), Wi-Fi (trade name), ZigBee (trade name), IrDA, or a wireless USB.

The storage 19 stores various programs and various types of data necessary for the operation of the multifunction peripheral 10. The storage 19 may be constituted by, for example, a storage device such as a random access memory (RAM), a hard disk drive (HDD), a solid state drive (SSD), or a read only memory (ROM).

In the present embodiment, the storage 19 stores a control program 191, an authentication program 192, an import data verification program 193, and a device setting management program 194 and includes a device setting storage area 195.

The control program 191 is a program read by the controller 11 when the controller 11 performs centralized control of the multifunction peripheral 10. The controller 11 that has read the control program 191 controls driving of the display 13, the operation inputter 15, the communicator 17, and the like to perform the function of the processing device 1 according to the present disclosure, and further controls driving of the image processor 21 and the image inputter 23 to perform setting, execution, post-processing, and the like of each job such as copy, print, scan, fax, or mail transmission/reception.

The authentication program 192 is a program read by the controller 11 when the controller 11 performs authentication processing between the multifunction peripheral 10 and the authentication service 50. The controller 11 that has read the authentication program 192 functions as an authenticator and can perform authentication processing (SMTP authentication method, POP authentication method, or the like) of performing authentication based on a combination of a username (user ID) and a password, in addition to an authentication method such as the OAuth 2.0 authentication.

The import data verification program 193 is a program read by the controller 11 when the controller 11 imports, as import data, export data exported from the multifunction peripheral 30 or the like. The controller 11 that has read the import data verification program 193 verifies the import data and determines whether or not the import data can be reflected in the device setting stored in the device setting storage area 195. The verification processing of the import data by the controller 11 that has read the import data verification program 193 will be described below.

The device setting management program 194 is a program read by the controller 11 when the controller 11 manages the device setting of the multifunction peripheral 10 such as setting information for executing a job in each mode such as copy, print, scan, fax, or mail transmission/reception, history information, user information of a user who uses the multifunction peripheral, and authentication information for the authentication service 50. Based on the verification result of the import data, the controller 11 that has read the device setting management program 194 manages the device setting by, for example, rewriting, updating, or deleting the existing device setting managed in the device setting storage area 195.

The device setting storage area 195 is a storage area for storing the device setting of the multifunction peripheral 10. The device setting storage area 195 includes an authentication information storage area 1951 for storing, as a device setting, authentication information for the authentication service 50 and the mail server 70. When the OAuth authentication method is set as the authentication method of the multifunction peripheral 10, the authentication information storage area 1951 stores the authentication method (OAuth authentication), an account name, a server information (the server ID of the mail server 70), and the like as first authentication information, and a token as second authentication information. That is, the multifunction peripheral 10 can apply the first authentication information such as the account name and the server information and perform authentication to the authentication service using the token as the second authentication information. When the SMTP authentication method is set as the authentication method, the authentication information storage area 1951 stores the authentication method (SMTP authentication), an account name, a password, server information (the server address of the mail server 70), and the like as authentication information. Note that the authentication information storage area 1951 may store authentication information and the like related to login authentication of the multifunction peripheral 10.

The image processor 21 forms an image based on image data on a sheet or the like serving as a recording medium. The image processor 21 feeds a sheet from a feed tray (not illustrated), forms an image on the sheet based on image data, and then discharges the sheet to a paper discharger (not illustrated). The image processor 21 can be constituted by, for example, a laser printer using an electrophotographic system. In this case, the image processor 21 performs image formation using toners supplied from toner cartridges (not illustrated) corresponding to toner colors (for example, cyan, magenta, yellow, and black). The image processor 21 may perform, for example, shading correction or density correction on image data input from the image inputter 23 to generate output image data for image transmission.

The image inputter 23 generates image data by scanning a document. The image inputter 23 can be configured as a scanner device that is provided with an image sensor such as a charge coupled device (CCD) or a contact image sensor (CIS), and that includes an automatic document feeder (ADF), a flatbed on which a document is placed to be read, and the like. The configuration of the image inputter 23 is not particularly limited as long as the image inputter 23 can generate image data by reading a reflected light image from an original image using the image sensor. Note that the image inputter 23 can be configured as an interface that can acquire image data stored in a portable storage medium such as a universal serial bus (USB) memory and image data transmitted from an external terminal device (not illustrated).

### 1.2.2 Multifunction Peripheral 30

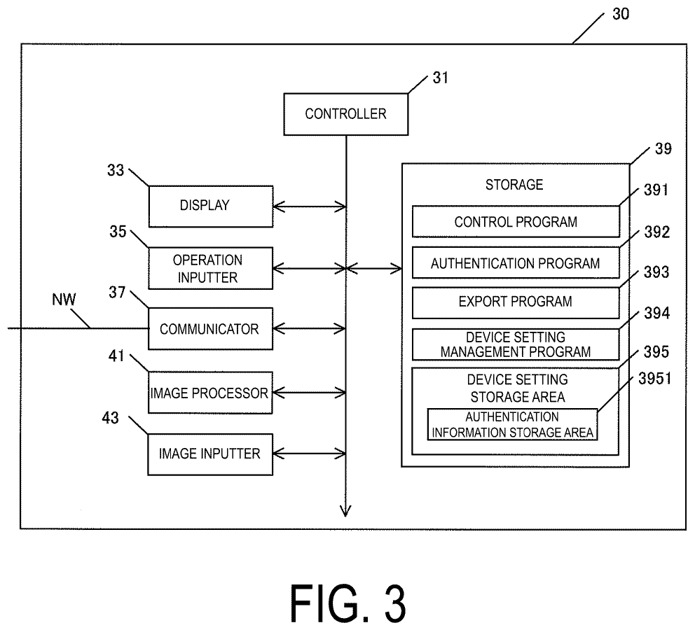

FIG. 3 is a functional configuration diagram of the multifunction peripheral 30. The multifunction peripheral 30 includes a controller 31, a display 33, an operation inputter 35, a communicator 37, a storage 39, an image processor 41, and an image inputter 43. Since the multifunction peripheral 30 can have the same or substantially the same device configuration and functional configuration as those of the multifunction peripheral 10, only the reference numerals are changed for the same configurations as those of the multifunction peripheral 10, and description thereof is omitted.

The storage 39 of the multifunction peripheral 30 stores a control program 391, an authentication program 392, an export program 393, and a device setting management program 394 and includes a device setting storage area 395.

The export program 393 is a program read by the controller 31 of the multifunction peripheral 30 when the device setting of the multifunction peripheral 30 stored in the device setting storage area 395 is exported as export data. The controller 31 of the multifunction peripheral 30 reads authentication information according to the following (1) to (3) from the device setting storage area 395 (authentication information storage area 3951) based on the authentication method set for the multifunction peripheral 30, in addition to setting information for executing a job in each mode such as copy, print, scan, fax, or mail transmission/reception, history information, user information of a user who uses the multifunction peripheral, and exports the authentication information in an extensible markup language (XML) format, for example. Note that, in the present embodiment, the setting value of the device setting is expressed by a tag represented in the XML format as described below. In the present embodiment, although the set of tags exported in the XML format is common, the setting value of each device setting expressed by the tag can be read as a specific setting value, no setting value, or a blank for a setting item not used in accordance with each authentication method.
(1) When the OAuth authentication method is set as the authentication method in the multifunction peripheral 30, third authentication information including the authentication method (OAuth authentication), an account name, and a server information (the server ID of the mail server 70).
(2) When the SMTP authentication method is set as the authentication method in the multifunction peripheral 30, fourth authentication information such as the authentication method (SMTP authentication), an account name, a password, and server information (the server address of the mail server 70).
(3) When neither the OAuth authentication method nor the SMTP authentication method is set as the authentication method in the multifunction peripheral 30 (no authentication), authentication information such as server information (the server address of the mail server 70).

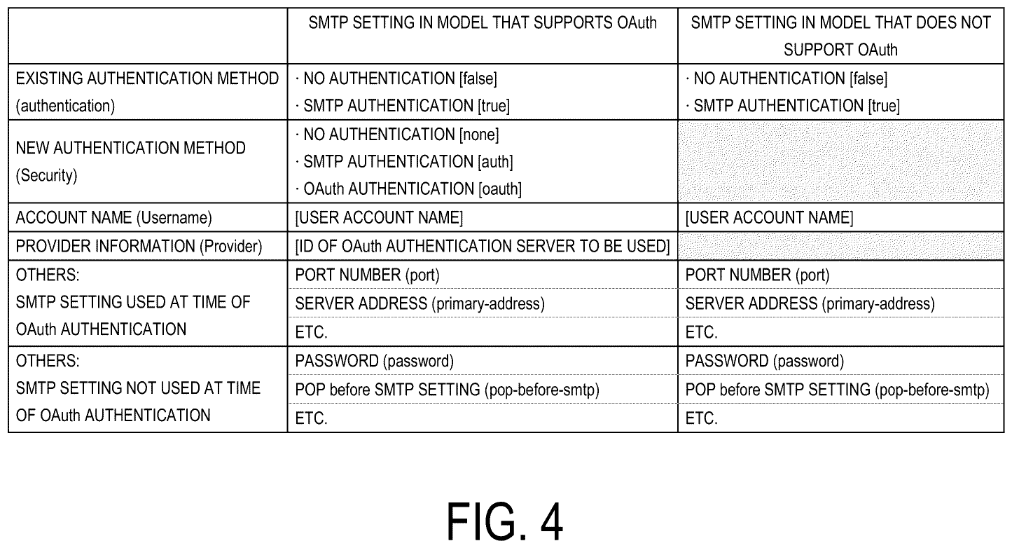

Here, SMTP setting items in a multifunction peripheral that supports the OAuth authentication method (SMTP setting in a model that supports the OAuth) and SMTP setting items in a multifunction peripheral that does not support the OAuth authentication method (SMTP setting in a model that does not support the OAuth) will be described with reference to FIG. 4. In FIG. 4, tag names described in the XML format, which is a data format of the export data, are described in parentheses, and data (setting values) represented by the tag names are described in square brackets. In addition, values after “·” represent legends.

FIG. 4 illustrates an example of SMTP setting items including an existing authentication method (authentication), a new authentication method (security), an account name (username), provider information (provider), others: SMTP setting used at the time of the OAuth authentication, and others: SMTP setting not used at the time of the OAuth authentication.

The existing authentication method (authentication) is a setting item for setting whether or not the SMTP authentication as the existing authentication method is valid. When the SMTP authentication is “valid” as the existing authentication method, the setting value is set to [true]. On the other hand, when the SMTP authentication is “invalid”, that is, when the existing authentication method is “no authentication”, the setting value is set to [false].

The new authentication method (security) is a setting item (new tag) provided in the SMTP setting of the multifunction peripheral that supports the OAuth authentication method, and a setting value of any of “no authentication [none]”, “SMTP authentication [auth]”, and “OAuth authentication [oauth]” is set based on the authentication setting of the multifunction peripheral.

The account name (username) is a setting item for setting [user account name].

The provider information (provider) is a setting item (tag) provided in the SMTP setting in the multifunction peripheral that supports the OAuth authentication method and is a setting item for setting [the ID of the OAuth authentication server to be used].

Others: SMTP setting used at the time of the OAuth authentication represents SMTP setting items used at the time of the OAuth authentication and include setting items such as a port number (port) and a server address (primary-address).

Others: SMTP setting not used at the time of the OAuth authentication represents SMTP setting items not used at the time of the OAuth authentication and include setting items such as a password and a POP before SMTP setting (pop-before-smtp).

FIG. 4 illustrates a mere example, and the SMTP setting items according to the present disclosure are not limited to the example illustrated in FIG. 4. Note that, in addition to the SMTP setting items in FIG. 4, the POP setting is handled in a similar manner (not illustrated).

### 1.2.3 Authentication Service 50 and Mail Server 70

The authentication service 50 can have a known configuration capable of implementing an authorization code flow based on the OAuth authentication method. Thus, the functional configuration of the authentication service 50 is not described herein. In addition, the mail server 70 supports the OAuth authentication method or the SMTP authentication method and can have a known configuration capable of providing a service related to mail transmission/reception according to the success or failure of an authentication result based on acquired authentication information such as a username (user ID), a password, or a token. Thus, the functional configuration of the mail server 70 is not described herein.

### 1.3 Processing Flow

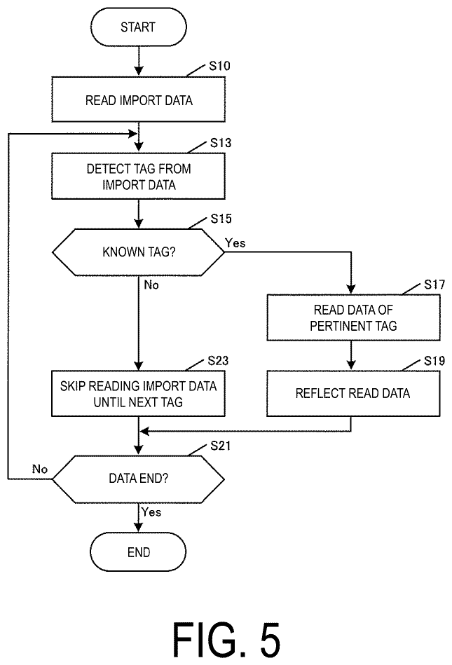

Next, a processing flow according to the present embodiment will be described. First, normal import processing in the multifunction peripheral 10 will be described with reference to a flowchart of FIG. 5. The controller 11 of the multifunction peripheral 10 executes the following processing by reading the import data verification program 193 and the device setting management program 194.

Note that, in the present disclosure, a tag (device setting) represented in the XML format is expressed in the following manner, for example.
<authentication>
   <data>
      <value>false</value>
   </data>
</authentication>

In the present disclosure, the setting value (value) of the device setting expressed by each tag may be referred to as data when there is no need to distinguish therebetween.

First, the controller 11 reads export data exported from the multifunction peripheral 30 as import data (step S10).

Next, the controller 11 detects a tag from the read import data (step S13).

The controller 11 determines whether or not the read tag is a known tag (step S15). Here, the known tag is a tag that the controller 11 that has read the import data verification program 193 holds for verification of the import data. When the tag detected from the import data matches the held tag, the controller 11 can determine that the tag is the known tag.

If it is determined that the read tag is the known tag, the controller 11 reads data of the tag (Yes in step S15 and proceeding to step S17). Next, the controller 11 reflects the read data in the device setting (step S19).

The controller 11 determines whether or not the import data has been completely read (step S21). If it is determined that the import data has been completely read, the controller 11 ends the processing (Yes in step S21 and proceeding to the end). On the other hand, if it is determined that the import data has not been completely read, the controller 11 returns the processing to step S13 (No in step S21 and proceeding to step S13).

Meanwhile, if it is determined in step S15 that the read tag is not the known tag, the controller 11 skips reading the import data until the next tag (No in step S15 and proceeding to step S23). Then, the controller 11 determines whether or not the import data has been completely read (step S21). If it is determined that the import data has been completely read, the controller 11 ends the processing (Yes in step S21 and proceeding to the end). On the other hand, if it is determined that the import data has not been completely read, the controller 11 returns the processing to step S13 (No in step S21 and proceeding to step S13).

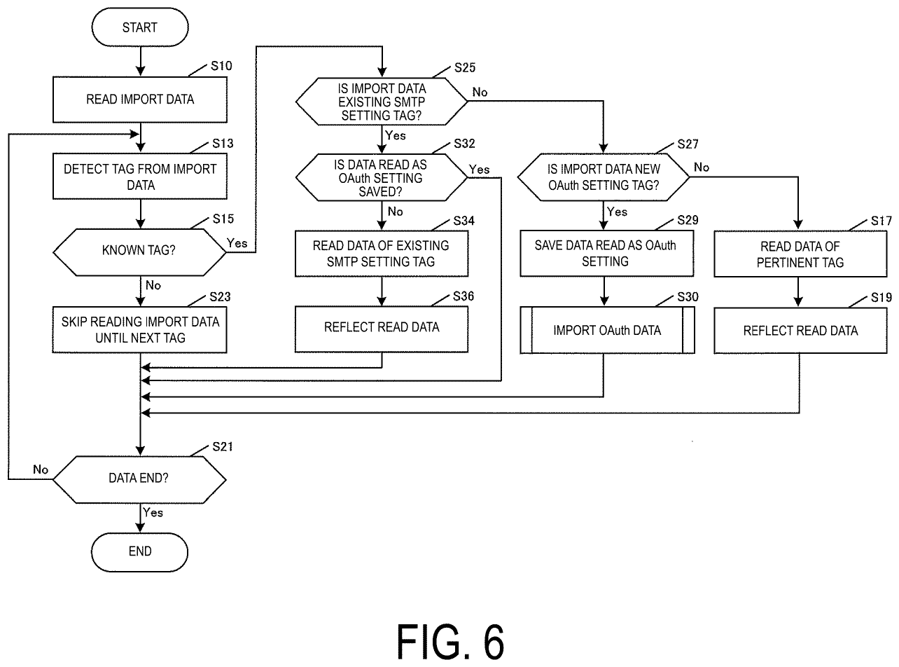

Next, processing of importing export data exported from the multifunction peripheral 30 that supports the OAuth authentication method will be described with reference to a flowchart of FIG. 6. The controller 11 of the multifunction peripheral 10 executes the following processing by reading the import data verification program 193 and the device setting management program 194. Note that the same processing operations as those described in FIG. 5 are denoted by the same step numbers, and description thereof is omitted.

If it is determined in step S15 that the read tag is the known tag, the controller 11 determines whether or not the import data is an existing SMTP setting tag (Yes in step S15 and proceeding to step S25). If it is determined that the import data is not the existing SMTP setting tag, the controller 11 determines whether or not the import data is a new OAuth setting tag (No in step S25 and proceeding to step S27).

If it is determined that the import data is the new OAuth setting tag, the controller 11 holds the data (OAuth data) read as the OAuth setting (Yes in step S27 and proceeding to step S29). Then, the controller 11 imports the held OAuth data (step S30).

After importing the OAuth data, the controller 11 determines whether or not the import data has been completely read (step S21). If it is determined that the import data has been completely read, the controller 11 ends the processing (Yes in step S21 and proceeding to the end). On the other hand, if it is determined that the import data has not been completely read, the controller 11 returns the processing to step S13 (No in step S21 and proceeding to step S13).

On the other hand, if it is determined that the import data is not the new OAuth setting tag, the controller 11 executes processing from step S17 to step S21 (No in step S27 and proceeding to step S17, step S19, and step S21).

Here, if it is determined in step S25 that the import data is the existing SMTP setting tag, that is, if it is determined that the import data includes the SMTP authentication information as the fourth authentication information, which is not information for the OAuth authentication method, the controller 11 determines whether or not the data (OAuth data) read as the OAuth setting is held (Yes in step S25 and proceeding to step S32).

If it is determined that the OAuth data is held, the controller 11 determines whether or not the import data has been completely read (Yes in step S32 and proceeding to step S21). If it is determined that the import data has been completely read, the controller 11 ends the processing (Yes in step S21 and proceeding to the end). On the other hand, if it is determined that the import data has not been completely read, the controller 11 returns the processing to step S13 (No in step S21 and proceeding to step S13).

On the other hand, if it is determined that the OAuth data is not held, the controller 11 reads data of the existing SMTP setting tag (No in step S32 and proceeding to step S34). Then, the controller 11 reflects the data read in step S34 in the device setting (step S36). After reflecting the read data, the controller 11 determines whether or not the import data has been completely read (step S21). If it is determined that the import data has been completely read, the controller 11 ends the processing (Yes in step S21 and proceeding to the end). On the other hand, if it is determined that the import data has not been completely read, the controller 11 returns the processing to step S13 (No in step S21 and proceeding to step S13).

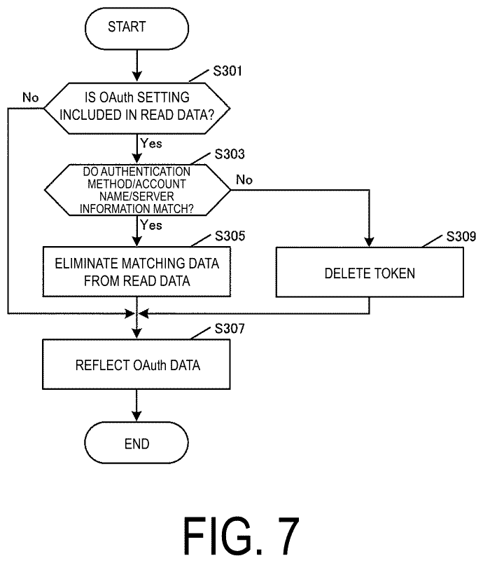

Next, processing of importing the OAuth data in step S30 of FIG. 6 will be described with reference to a flowchart of FIG. 7. Note that the controller 11 executes the following processing by reading the import data verification program 193 and the device setting management program 194 for the processing described with reference to FIG. 7.

When the OAuth data import processing starts, the controller 11 determines whether or not the OAuth setting is included in the read data (step S301). If it is determined that the OAuth setting is included in the read data, the controller 11 determines whether or not the authentication method, the account name, and the server information included in the read data match the authentication method, the account name, and the server information of the device setting held by the multifunction peripheral 10 (Yes in step S301 and proceeding to step S303).

If it is determined that the authentication method, the account name, and the server information included in the read data match the authentication method, the account name, and the server information of the device setting held by the multifunction peripheral 10, the controller 11 eliminates the matching data from the read data (Yes in step S303 and proceeding to step S305). Then, the controller 11 reflects the OAuth data in the device setting of the multifunction peripheral 10 (step S307) and ends the processing.

On the other hand, if it is determined that the authentication method, the account name, and the server information included in the read data do not match the authentication method, the account, and the server information of the device setting held by the multifunction peripheral 10, the controller 11 deletes the held token serving as the second authentication information (No in step S303 and proceeding to step S309). Then, the controller 11 reflects the OAuth data in the device setting of the multifunction peripheral 10 (step 307) and ends the processing.

### 1.4 Configuration of Export Data

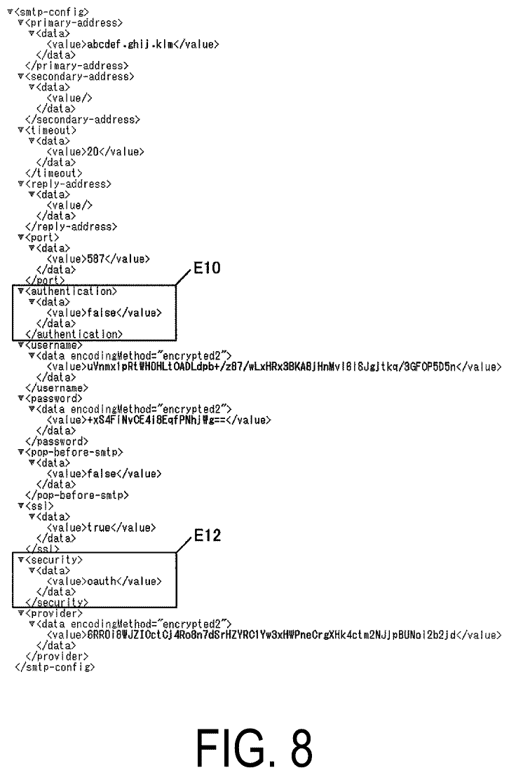

Next, a specific configuration example of the export data according to the present disclosure will be described with reference to FIG. 8 to FIG. 16.

FIG. 8 is a diagram for illustrating an outline of export data exported by a multifunction peripheral (for example, the multifunction peripheral 30) that supports the OAuth authentication method when the authentication method is set to the OAuth authentication. FIG. 8 illustrates a setting item (child tag) portion included in the <smtp-config></smtp-config> tag extracted from the export data in the XML format.

The <authentication></authentication> tag indicated by a frame E10 is a tag indicating whether or not the SMTP setting as the existing authentication method is valid. In the condition of the example illustrated in FIG. 8, since the authentication method is the OAuth authentication method, the setting value of the <authentication></authentication> tag is set to [false].

The <security></security> tag indicated by a frame E12 is a new tag related to a newly added setting item and indicates that the authentication method of the multifunction peripheral is set to the OAuth authentication method ([oauth]).

Moreover, the setting value of the <username></username> tag representing the account name and the setting value of the <provider></provider> tag representing the provider information are set as in the example illustrated in FIG. 8, and these setting values are encrypted by the “encrypted2” method.

Note that although the <password></password> tag representing the password is blank, a blank character string is encrypted and thus the value is not blank as the XML data.

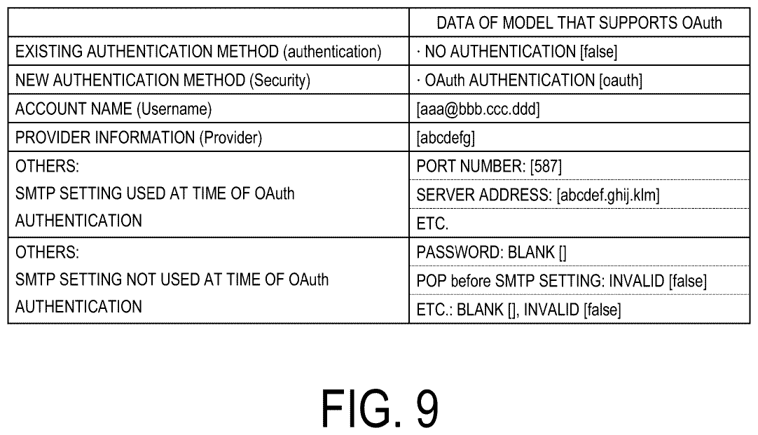

FIG. 9 is a diagram illustrating main setting items of the export data in the example illustrated in FIG. 8 in a table format. The setting items illustrated in FIG. 9 represent setting items recognized as tags when the export data in the example illustrated in FIG. 8 is imported to a multifunction peripheral (for example, the multifunction peripheral 10) that supports the OAuth authentication method, and setting values set in these tags.

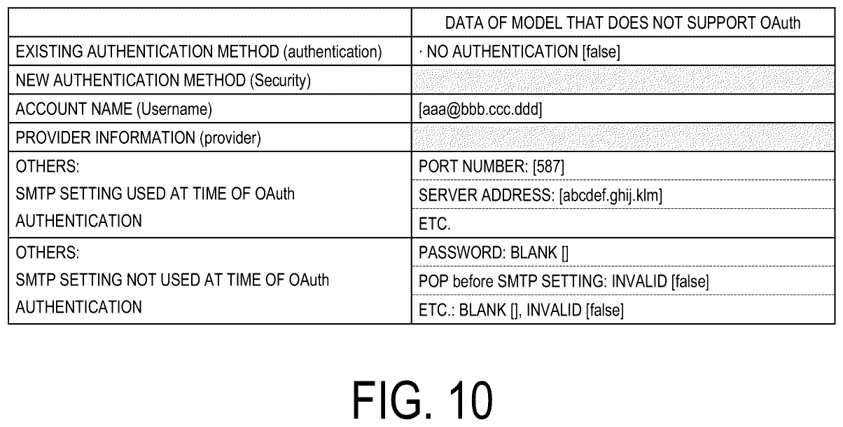

On the other hand, the setting items illustrated in FIG. 10 represent setting items recognized as tags when the export data in the example illustrated in FIG. 8 is imported to a multifunction peripheral that does not support the OAuth authentication method, and setting values set in these tags. The multifunction peripheral that does not support the OAuth authentication method cannot support the OAuth authentication method. Thus, when the export data is imported, the <security></security> tag representing the new authentication method and the <provider></provider> tag representing the provider information are not recognized.

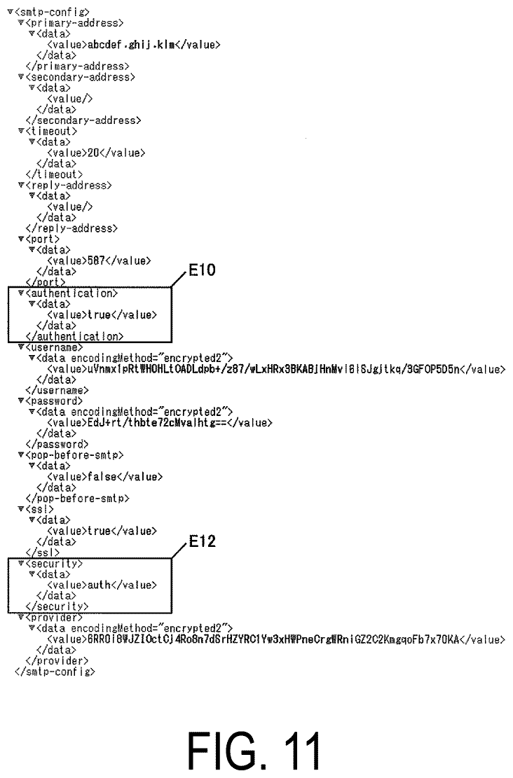

FIG. 11 is a diagram for illustrating an outline of export data exported by a multifunction peripheral (for example, the multifunction peripheral 30) that supports the OAuth authentication method when the authentication method is set to the SMTP authentication. FIG. 11 illustrates a setting item (child tag) portion included in the <smtp-config></smtp-config> tag extracted from the export data in the XML format.

The <authentication></authentication> tag indicated by a frame E10 is a tag indicating whether or not the SMTP setting as the existing authentication method is valid. In the condition of the example illustrated in FIG. 11, since the authentication method is the SMTP authentication method, the setting value of the <authentication></authentication> tag is set to [true].

The <security></security> tag indicated by a frame E12 is a new tag related to a newly added setting item and indicates that the authentication method of the multifunction peripheral is set to the SMTP authentication method ([auth]).

In addition, the setting value of the <username></username> tag representing the account name and the setting value of the <password></password> tag representing the password are set as in the example illustrated in FIG. 11, and these setting values are encrypted by the “encrypted2” method.

Note that although the setting value of the <provider></provider> tag representing the provider information is blank, a blank character string is encrypted and thus the value is not blank as the XML data.

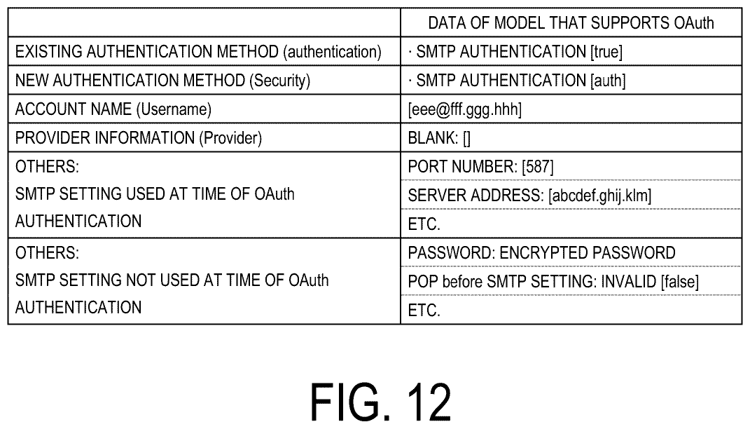

FIG. 12 is a diagram illustrating main setting items of the export data in the example illustrated in FIG. 11 in a table format. The setting items illustrated in FIG. 12 represent setting items recognized as tags when the export data in the example illustrated in FIG. 11 is imported to a multifunction peripheral (for example, the multifunction peripheral 10) that supports the OAuth authentication method, and setting values set in these tags.

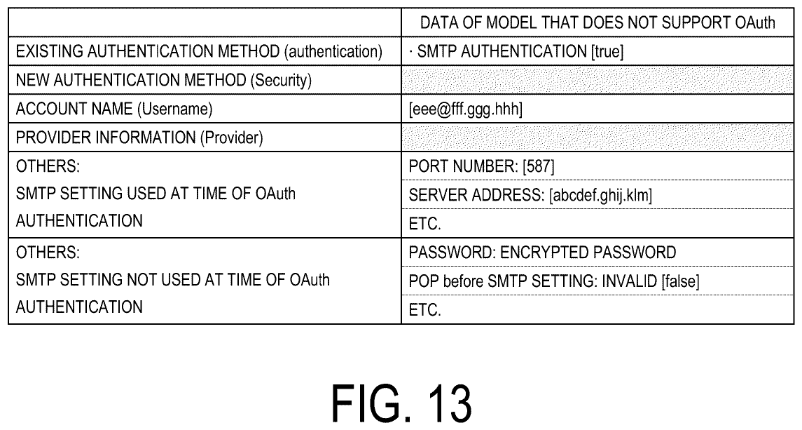

On the other hand, setting items illustrated in FIG. 13 represent setting items recognized as tags when the export data in the example illustrated in FIG. 11 is imported to a multifunction peripheral that does not support the OAuth authentication method, and setting values set in these tags. The multifunction peripheral that does not support the OAuth authentication method cannot support the OAuth authentication method. Thus, when the export data is imported, the <security></security> tag representing the new authentication method and the <provider></provider> tag representing the provider information are not recognized.

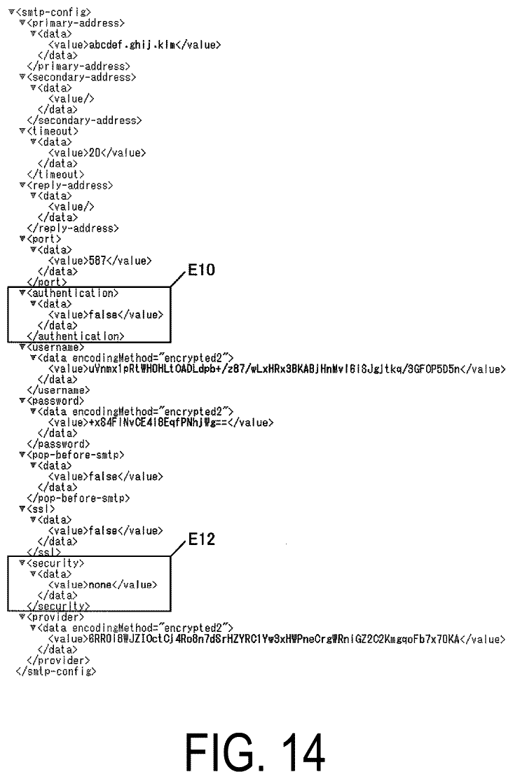

FIG. 14 is a diagram for illustrating an outline of export data exported by a multifunction peripheral (for example, the multifunction peripheral 30) that supports the OAuth authentication method when the authentication method is set to no authentication. FIG. 14 illustrates a setting item (child tag) portion included in the <smtp-config></smtp-config> tag extracted from the export data in the XML format.

The <authentication></authentication> tag indicated by a frame E10 is a tag indicating whether or not the SMTP setting as the existing authentication method is valid. In the condition of the example illustrated in FIG. 14, since the authentication method is no authentication, the setting value of the <authentication></authentication> tag is set to [false].

The <security></security> tag indicated by a frame E12 is a new tag related to a newly added setting item and indicates that the authentication method of the multifunction peripheral is set to no authentication ([none]).

Moreover, the setting value of the <username></username> tag representing the account name is set as in the example illustrated in FIG. 14, and the setting value is encrypted by the “encrypted2” method.

Note that although the <password></password> tag representing the password is blank, a blank character string is encrypted and thus the value is not blank as the XML data.

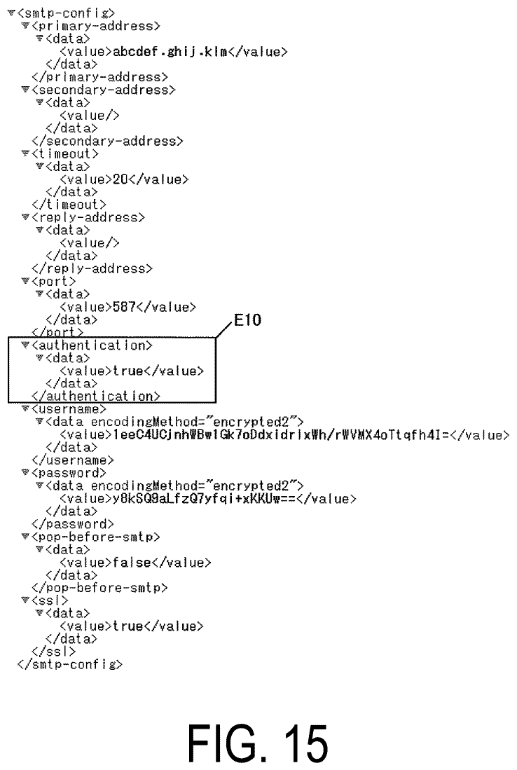

FIG. 15 is a diagram for illustrating export data exported by a multifunction peripheral that does not support the OAuth authentication method when the authentication method is set to the SMTP authentication. FIG. 15 illustrates a setting item (child tag) portion included in the <smtp-config></smtp-config> tag extracted from the export data in the XML format.

The <authentication></authentication> tag indicated by a frame E10 is a tag indicating whether or not the SMTP setting as the existing authentication method is valid. In the condition of the example illustrated in FIG. 15, since the authentication method is the SMTP authentication method, the setting value of the <authentication></authentication> tag is set to [true].

The <security></security> tag indicated by the frame E12 in the example illustrated in each of FIG. 8, FIG. 11, and FIG. 14 is not provided in the example illustrated in FIG. 15 because the multifunction peripheral does not support the OAuth authentication method.

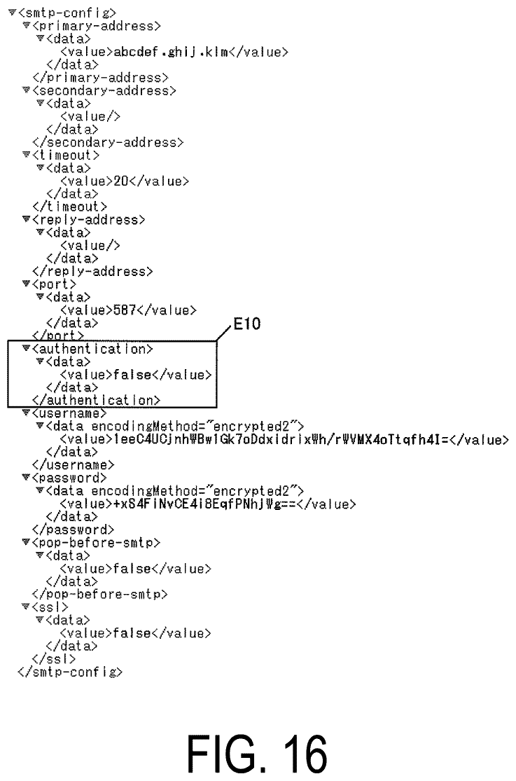

FIG. 16 is a diagram for illustrating an outline of export data exported by a multifunction peripheral that does not support the OAuth authentication method when the authentication method is set to no authentication. FIG. 16 illustrates a setting item (child tag) portion included in the <smtp-config></smtp-config> tag extracted from the export data in the XML format.

The <authentication></authentication> tag indicated by a frame E10 is a tag indicating whether or not the SMTP setting as the existing authentication method is valid. In the condition of the example illustrated in FIG. 16, since the authentication method is no authentication, the setting value of the <authentication></authentication> tag is set to [false].

The <security></security> tag indicated by the frame E12 in the example illustrated in each of FIG. 8, FIG. 11, and FIG. 14 is not provided in the example illustrated in FIG. 16 because the multifunction peripheral does not support the OAuth authentication method.

### 1.5 Operation Examples

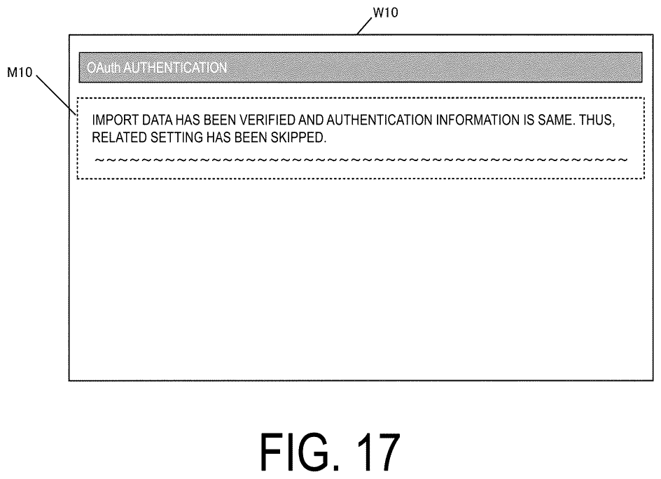

Next, operation examples according to the present embodiment will be described. FIG. 17 is a diagram for illustrating an operation example related to the OAuth data import processing explained with reference to the flowchart of FIG. 7. FIG. 17 is a diagram for illustrating a configuration example of a notification screen W10 for notifying that the matching data is eliminated from the read data and the related setting is skipped when it is determined that the authentication method, the account name, and the server information included in the OAuth data (read data) match the authentication method, the account name, and the server information of the device setting held by the multifunction peripheral 10.

The notification screen W10 includes a message screen M10 having a notification content “The import data has been verified and the authentication information is the same. Thus, the relevant setting has been skipped.”. The user can recognize that the related setting has been skipped in the import processing by checking the display content of the message screen M10.

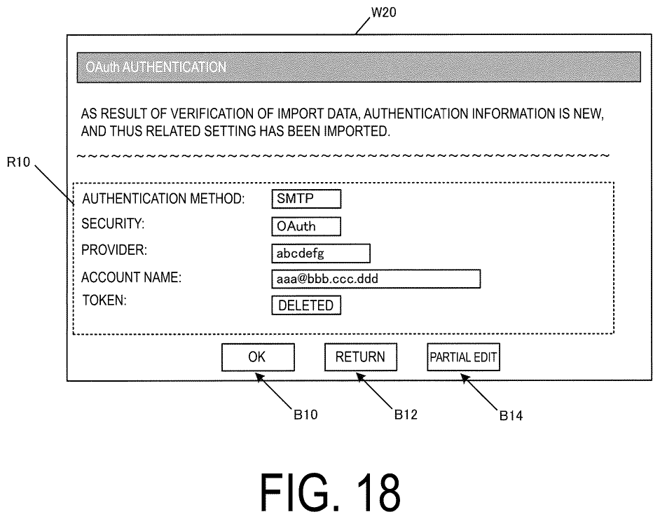

FIG. 18 is a diagram for illustrating a configuration example of a notification screen W20 for notifying that the token is deleted and the import data is reflected in the device setting when it is determined that the authentication method, the account name, and the server information included in the OAuth data (read data) do not match the authentication method, the account name, and the server information of the device setting held by the multifunction peripheral 10.

The notification screen W20 includes a reflection information notification area R10, an OK button B10, a return button B12, and a partial edit button B14.

The reflection information notification area R10 is an area for notifying the device setting in which the import data is reflected. FIG. 18 illustrates an example in which the authentication method, security, provider, and account name are listed as the device setting in which the import data is reflected. At this time, by notifying that the token has been deleted as in the example illustrated in FIG. 18, the user can recognize that re-authorization by a (administrator) user is necessary. In this case, for example, a notification screen or a notification area (not illustrated) may be separately provided, and the user may be notified that re-authorization by the (administrator) user is necessary.

The OK button B10 is a button for receiving permission of the reflection result of the import data. When the OK button B10 is selected by the user, the controller 11 determines that the import data is permitted to be reflected in the device setting and ends display of the notification screen W20. The return button B12 is a button for receiving selection for returning the device setting to the state before the import data is reflected. When the return button B12 is selected by the user, the controller 11 returns the device setting to the state before the import data is imported. The partial edit button B14 is a button for receiving an instruction to edit the device setting after the import data is reflected. When the partial edit button B14 is selected by the user, the controller 11 makes the device setting notified in the reflection information notification area R10 editable and receives the edit instruction from the user. The controller 11 edits the device setting based on the received edit instruction.

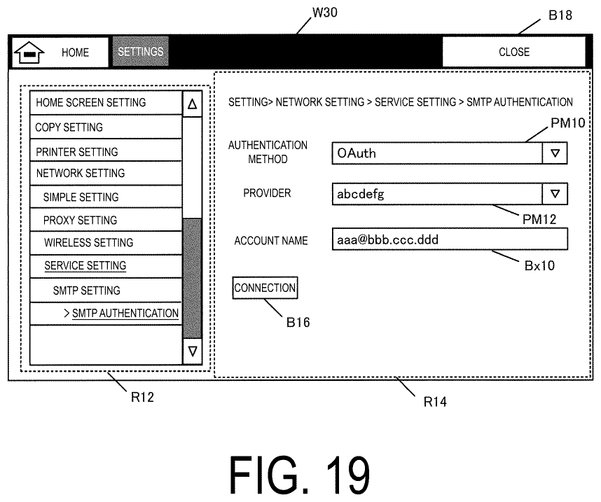

FIG. 19 is a diagram for illustrating a configuration example of an authorization processing screen W30 for displaying the reflection result of the import data. The authorization processing screen W30 can be displayed as one screen of a system setting screen for receiving a system setting of the multifunction peripheral 10.

The authorization processing screen W30 includes a selection item display area R12, an advanced setting area R14, and a close button B18.

The selection item display area R12 is an area in which setting items that can be set by the user are displayed in a selectable manner. FIG. 19 illustrates an example in which home screen setting, copy setting, printer setting, and network setting are displayed as items that can be selected by the user.

The advanced setting area R14 is an area for displaying setting items for receiving input of setting values and the like for an item selected in the selection item display area R12. Note that FIG. 19 illustrates an example in which a setting screen related to the SMTP authentication setting is displayed in the advanced setting area R14.

The advanced setting area R14 includes an authentication method pull-down menu PM10, a provider pull-down menu PM12, an account name input box Bx10 for receiving input of an account name for the provider, and a connection button B16.

The authentication method pull-down menu PM10 is a pull-down menu for receiving selection of an authentication method. FIG. 19 illustrates an example of a state in which the OAuth authentication method is displayed in a selectable manner as an authentication method.

The provider pull-down menu PM12 is a pull-down menu for receiving selection of the authentication service 50 as an authentication destination necessary for the OAuth authentication. When a downward arrow provided at an edge portion of the menu is selected by the user, the provider pull-down menu PM12 displays a selectable provider name. FIG. 19 illustrates an example of a state in which “abcdefg” is displayed as a provider in a selectable manner.

The account name input box Bx10 is an input box for receiving input of an account name for the provider “abcdefg”. FIG. 19 illustrates an example of a state in which “aaa@bbb.ccc.ddd” is displayed such that it can be input as an account name for the provider “abcdefg”.

The connection button B16 is a button for receiving an instruction to start authorization processing with the provider “abcdefg”. Upon receiving the instruction to select the connection button B16 from the user, the controller 11 starts the authorization processing with the provider “abcdefg”.

The close button B18 is a button for receiving an instruction to end display of the authorization processing screen W30. When the user selects the close button B18, the controller 11 ends display of the authorization processing screen W30.

As described above, according to the present embodiment, when the authentication information related to the OAuth authentication is imported to the device that supports the OAuth authentication method, rewriting of the existing first authentication information is omitted and the token serving as the second authentication information is maintained in a case where the imported authentication information is the same as the first authentication information serving as the existing device setting of the import destination, and the first authentication information is rewritten with the imported authentication information and the token is deleted in a case where the imported authentication information is different from the existing first authentication information. Thus, it is possible to provide a processing device and the like capable of appropriately reflecting the authentication information related to the OAuth authentication in the device setting of the import destination without incorrectly reusing the token.

### 2. Second Embodiment

As a second embodiment, a mode will be described in which, when imported authentication information is the same as first authentication information serving as an existing device setting of an import destination, only the first authentication information is rewritten and rewriting of second authentication information is restricted.

Since the functional configuration according to the second embodiment can be similar to the functional configuration according to the first embodiment, description thereof will be omitted here.

### 2.1 Processing Flow

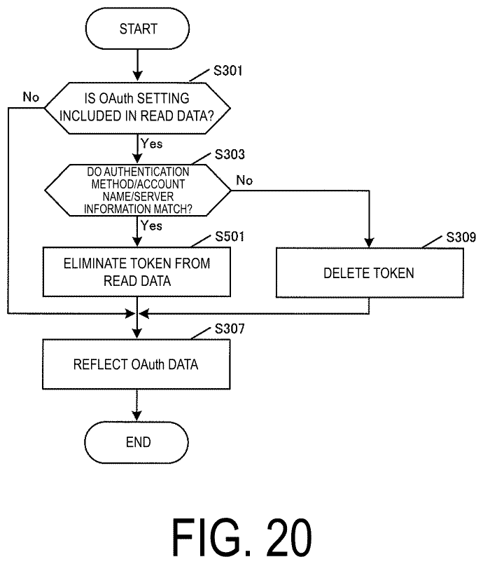

OAuth data import processing according to the second embodiment can be explained with reference to a flowchart in which FIG. 7 is replaced with FIG. 20. Since other processing operations can be similar to those of the first embodiment, description thereof is omitted here. Moreover, in FIG. 20, processing operations that can be executed in a similar manner to those of FIG. 7 are denoted by the same step numbers, and description thereof is omitted.

In Step S303 of FIG. 20, if it is determined that the authentication method, the account name, and the server information included in the read data match the authentication method, the account name, and the server information of the device setting held by the multifunction peripheral 10, the controller 11 restricts rewriting of the second authentication information by eliminating the token from the read data (Yes in step S303 and proceeding to Step S501). Then, the controller 11 reflects the OAuth data in the device setting of the multifunction peripheral 10 (step S307) and ends the processing.

According to the second embodiment, when the imported authentication information is the same as the first authentication information serving as the existing device setting of the import destination, it is possible to rewrite only the first authentication information and restrict rewriting of the token serving as the second authentication information. Thus, a similar effect as that of the first embodiment can be achieved.

### 3. Third Embodiment

As a third embodiment, a mode will be described in which when imported authentication information is different from first authentication information serving as an existing device setting of an import destination, a token serving as second authentication information is maintained without being deleted, and the first authentication information is rewritten with the imported authentication information.

Since the functional configuration according to the third embodiment can be similar to the functional configuration according to the first embodiment, description thereof will be omitted here.

### 3.1 Processing Flow

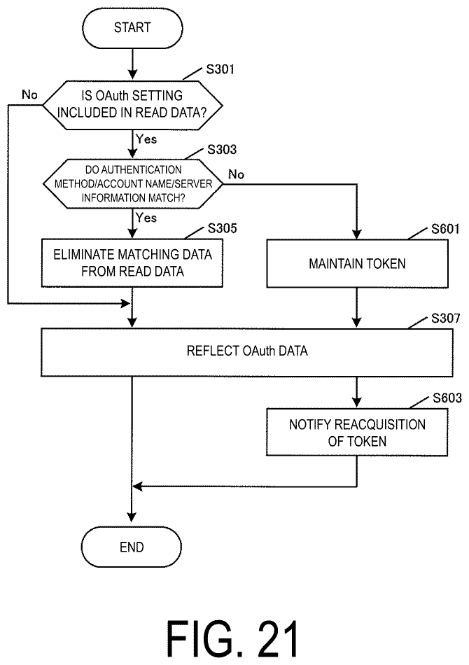

OAuth data import processing according to the third embodiment can be explained with reference to a flowchart in which FIG. 7 is replaced with FIG. 21. Since other processing operations can be similar to those of the first embodiment, description thereof is omitted here. Moreover, in FIG. 21, processing operations that can be executed in a similar manner to those of FIG. 7 are denoted by the same step numbers, and description thereof is omitted.

In step S303 of FIG. 21, if it is determined that the authentication method, the account name, and the server information included in the read data do not match the authentication method, the account name, and the server information of the device setting held by the multifunction peripheral 10, the controller 11 maintains the token related to the existing device setting without deleting the token (No in step S303 and proceeding to step S601). Then, the controller 11 reflects the OAuth data in the device setting of the multifunction peripheral 10 (step S307). Note that when the token is maintained without being deleted, the controller 11 notifies the user that reacquisition of the token by the administrator user is necessary and ends the processing (step S603).

According to the third embodiment, when the imported authentication information is different from the first authentication information serving as the existing device setting of the import destination, the token serving as the second authentication information is maintained. In this case, since the maintained token does not match the token corresponding to the rewritten first authentication information, the token is not incorrectly reused. Then, since it is notified that reacquisition of the token by the administrator user is necessary, the authentication information related to the OAuth authentication can be appropriately reflected in the device setting of the import destination while the token is not incorrectly reused.

### 4. Modified Example

The present disclosure is not limited to the embodiments described above and can be changed in various manners. In other words, embodiments obtained by combining technical mechanisms appropriately changed without departing from the gist of the present disclosure are also included in the technical scope of the present disclosure.

Although some parts of the above-described embodiments are described separately for convenience of explanation, it is a matter of course that combinations can be executed within a technically allowable range.

The programs running on each device in the embodiments are programs for controlling a CPU or the like (programs for causing a computer to function) to realize the aforementioned functions in the embodiments. The information handled by these devices is temporarily accumulated in a transitory storage device (for example, a RAM) at the time of processing, is then stored in a storage device such as a read only memory (ROM) or an HDD, and is read, corrected, and written by the CPU as needed.

The recording medium storing the programs may be any of a semiconductor medium (for example, a ROM, a nonvolatile memory card, or the like), an optical recording medium or a magneto-optical recording medium (for example, a digital versatile disc (DVD), a magneto optical disc (MO), a mini disc (MD), a compact disc (CD), a Blu-ray (trade name) disc (BD) or the like), a magnetic recording medium (for example, a magnetic tape, a flexible disk, or the like), and the like. Not only the aforementioned functions of the embodiments are realized by executing the loaded programs, but also the functions of the present disclosure may be realized by performing processing in cooperation with an operating system, another application program, or the like based on instructions of the programs.

In a case where the programs are distributed to the market, the programs can be stored and distributed in a portable recording medium, or can be transferred to a server computer connected via a network such as the Internet. In this case, it is a matter of course that the storage device of the server computer is also included in the present disclosure.

In addition, each functional block or each characteristic of the device used in the above-described embodiments can be implemented and executed by an electric circuit, for example, an integrated circuit or a plurality of the integrated circuits. An electric circuit designed to implement the function described herein may include a general-purpose processor, a digital signal processor (DSP), an application specific integrated circuit (ASIC), a field programmable gate array (FPGA) or other programmable logic devices, discrete gate or transistor logic, discrete hardware components, or a combination thereof. The general-purpose processor may be a microprocessor, or any known processor, controller, microcontroller, or state machine. The above-described electric circuit may be constituted by a digital circuit or an analog circuit. In addition, in a case where an integrated circuit technology that replaces the current integrated circuit becomes available due to advancement of the semiconductor technology, one or more aspects of the present disclosure can use a new integrated circuit based on the new integrated circuit technology.

### REFERENCE SIGNS LIST

1 Processing device
10, 30 Multifunction peripheral
11, 31 Controller
13, 33 Display
15, 35 Operation inputter
17, 37 Communicator
19, 39 Storage
21, 41 Image processor
23, 43 Image inputter
191, 391 Control program
192, 392 Authentication program
193 Import data verification program
393 Export program
194, 394 Device setting management program
195, 395 Device setting storage area
1951, 3951 Authentication information storage area
50 Authentication service
70 Mail server

1. A processing device comprising:
an authenticator that applies first authentication information and authenticates to a service using second authentication information;
a storage that stores a device setting including the first authentication information and the second authentication information; and
one or more controllers that verify import data imported to a device and reflects the import data on the device setting stored in the storage, wherein
the one or more controllers
compare third authentication information with the first authentication information when determining that the import data includes the third authentication information as a result of verification of the import data,
maintain the second authentication information when determining that the third authentication information and the first authentication information are the same authentication information, and
reflect the third authentication information instead of the first authentication information on the device setting and delete the second authentication information from the storage when determining that the third authentication information and the first authentication information are not the same authentication information.

2. The processing device according to claim 1, wherein
the import data is data in which a setting value of the device setting is represented in association with a tag, and
the one or more controllers verify the import data based on the tag detected.

3. The processing device according to claim 2, wherein
when the tag represents a setting value related to an authentication method of performing authentication to the service using the second authentication information, the one or more controllers determine that the import data includes the third authentication information.

4. The processing device according to claim 3, wherein
the authentication method is an OAuth authentication method.

5. The processing device according to claim 3, wherein
when the tag represents a setting value related to a different authentication method different from the authentication method, the one or more controllers determine that the import data includes fourth authentication information and reflect the fourth authentication information on the device setting.

6. The processing device according to claim 5, wherein
the different authentication method is an authentication method using a username and a password.

7. The processing device according to claim 1, wherein
the import data includes first device setting information, and
the one or more controllers
replace the device setting with a first device setting based on the first device setting information, and
regarding the third authentication information,
maintain the second authentication information when determining that the third authentication information and the first authentication information are the same authentication information, and
reflect the third authentication information instead of the first authentication information on the device setting and deletes the second authentication information from the storage when determining that the third authentication information and the first authentication information are not the same authentication information.

8. An image processing device comprising:
a processing device including
an authenticator that applies first authentication information and authenticates to a service using second authentication information,
a storage that stores a device setting including the first authentication information and the second authentication information, and
one or more controllers that verify import data imported to a device and reflect the import data on the device setting stored in the storage, the one or more controllers comparing third authentication information with the first authentication information when determining that the import data includes the third authentication information as a result of verification of the import data, maintaining the second authentication information when determining that the third authentication information and the first authentication information are the same authentication information, and reflecting the third authentication information instead of the first authentication information on the device setting and deleting the second authentication information from the storage when determining that the third authentication information and the first authentication information are not the same authentication information; and
an image processor that performs transmission processing of an image based on an authentication result in the service.

9. A processing method of import data, the processing method comprising:
storing a device setting including first authentication information and second authentication information in a storage device;
verifying import data imported to a device;
comparing third authentication information with the first authentication information when determining that the import data includes the third authentication information as a result of verification of the import data;
maintaining the second authentication information when determining that the third authentication information and the first authentication information are the same authentication information; and
reflecting the third authentication information instead of the first authentication information on the device setting and deleting the second authentication information from the storage device when determining that the third authentication information and the first authentication information are not the same authentication information.
